(19) United States
(12) Patent Application Publication
(10) Pub. No.: US 2005/0112351 A1
(43) Pub. Date: May 26, 2005

(54) Highly reflective optical element

(75) Inventors: Thomas M. Laney, Spencerport, NY (US); Kenneth W. Best JR., Hilton, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/719,762

(22) Filed: Nov. 21, 2003

(51) Int. Cl. B32B 3/26; B32B 27/00

(52) U.S. Cl. 428/304.4; 428/319.7

(57) ABSTRACT

A reflective optical film comprising a layer containing a polylactic acid voided with inorganic particles in a size and an amount sufficient to provide a visible light reflectivity of at least 96%. Optionally the film contains UV particles in amounts sufficient to provide a UV light reflectivity of less than 40%.

### CROSS-REFERENCE TO RELATED APPLICATION

This application is co-filed with commonly assigned applications entitled “HIGHLY REFLECTIVE OPTICAL ELEMENT”, Ser. No. ______, filed ______ under Attorney Docket No. 86349AEK, and “PHOSPHOR SCREEN AND IMAGING ASSEMBLY WITH POLY(LACTIC ACID) SUPPORT”, Ser. No. ______, filed ______ under Attorney Docket No. 86863JLT.

### FIELD OF THE INVENTION

The invention relates to a highly reflective optical film comprising a polylactic acid and having inorganic particles and fine voids in at least one layer of the film. The film is voided sufficient to provide diffuse reflectance of at least 96% and can exhibit reduced reflection of UV light below 40% by additional presence of UV absorbing particles. In a preferred form, the invention relates to a side light reflector film for liquid crystal display devices.

### BACKGROUND OF THE INVENTION

A side light system, such as system disclosed in JP-A-SHO 63-62104, has been broadly applied as a means to illuminate a liquid crystal display. The advantages of a side light system is that it can be made thin and can illuminate the display or board uniformly. In the side light system, halftone dots are printed on one surface of a transparent substrate having a certain thickness such as an acrylic plate, and a light from a light source such as a cold cathode ray tube is applied to the substrate through the edge of the substrate. The applied light is uniformly dispersed by the halftone dot print, and a scope having a uniform brightness can be obtained.

In such a light system, a reflective optical element or reflector must be provided on the back surface of transparent light guiding plate in order to prevent light from escaping through the back surface. This reflector must be thin and must have a high reflectance property. Although a metal deposited layer such as one disclosed in JP-A-SHO 62-169105 or a white synthetic paper such as one disclosed in JP-A-SHO 63-62104 has been used as the reflector, the deposited layer is expensive and the synthetic paper cannot produce a sufficient reflectance. Accordingly, in practice, a white polyester film in which a white pigment such as titanium oxide is added, such as one disclosed in JP-A-HEI 2-269382, has been used as the reflector. However, although the reflectance of the reflector can be increased to some extent by using such a white polyester film whitened by adding a pigment such as titanium oxide, the increase of the reflectance is limited to an insufficient level. Recently voided polyester films have been used, such as the ones disclosed in U.S. Pat. No. 5,672,409, as the reflector. The voided film described offers high reflectance in a broader range of wavelengths.

Although the reflectance of the reflector described in U.S. Pat. No. 5,672,409 was high it is still desirable to attain even higher visible reflectance. A survey of the most widely used commercial films for reflectors indicated that none had reflectance of at least 96% (see Table 1). It is desirable for reflective optical films to have as high a reflectance as possible. It is also desirable to make the reflector element as thin as possible in a display so as to minimize the entire display thickness. This is especially true in displays used in cell phones or PDA's(personal digital assistant).

Also, the reflector described in U.S. Pat. No. 5,672,409 has high average reflectance from 330-380 nm. Although this is claimed as an advantage in practice the elimination of light from 200 to 400 nm is desirable as this light can be damaging to the liquid crystal polymer in the display. This will become more of a problem as the other optical elements in the display are simplified, a trend in the industry. Much of the harmful UV light, 200 to 400 nm, is currently absorbed by the other optical elements in current displays but will likely not be the case in future more simplified screen designs. Therefore, an optical element or reflector is required that can achieve visible reflectivity of at least 96%. It is further required that reflectors be able to minimize reflectance at wavelengths from 200 to 400 nm.

### PROBLEM TO BE SOLVED BY THE INVENTION

There remains a need for an improved light reflective film, to provide improved visible light reflection while providing low reflectance of UV light.

### SUMMARY OF THE INVENTION

The invention provides a reflective optical film comprising a layer containing a polylactic acid voided with inorganic particles in a size and an amount sufficient to provide a visible light reflectivity of at least 96%. Also provided is such a film containing UV particles in amounts sufficient to provide a UV light reflectivity of less than 40%. Also provided is a display comprising such films.

The films provide improved visible light reflection while providing low reflectance of UV light

### DETAILED DESCRIPTION OF THE INVENTION

The invention is generally described above. Next, the present invention will be explained in more detail by embodiments and examples. However, the present invention is not restricted by the embodiments and examples.

The invention provides a reflective optical film, usable in a surface light source, which has a average reflectance in the visible wavelengths, 400 to 700 nm of least 96%. Additionally, the present invention can provide low reflectance, at wavelengths from 200 to 400 nm, below 40%.

A reflector used in a surface light source according to the present invention comprises a white poly(lactic acid) containing film in which fine voids containing inorganic particles are formed at a level sufficient to provide visible reflectance of at least 96%. Additionally the reflective film can have UV absorptive particles in an amount sufficient to minimize UV reflectance from 200 to 400 nm to below 40%. Namely, the white polylactic acid film is used as a substrate of a reflector for a surface light source. In the reflective optical element according to the present invention, fine voids are formed in the polylactic acid film by loading inorganic particles in a voided layer at levels between 25 and 70 wt %. If desired, UV reflectance is reduced to below 40% by loading UV absorbing particles in the voided layer. These particles can also serve as the void initiating inorganic particles. In such a case the loading should be between 25 and 70 wt %. Alternatively, the UV absorbing particles can be added in addition to the inorganic particles used as void initiators. In this case the loading is desirably between 0.5 and 10 wt %.

The white polylactic acid film used as a substrate for the reflective optical element according to the present invention must contain fine voids that are initiated by inorganic particles of sufficiently small size and concentration. The shape of the void is not particularly restricted, and the shape is typically an elongated sphere or ellipsoid or a flattened sphere. The size of the inorganic particles which initiate the voids upon stretching typically have an average particle size of 0.1 to 10.0, usually 0.3 to 2.0, and desirably 0.5 to 1.5 μm. Average particle size is that as measured by a Sedigraph 5100 Particle Size Analysis System(by PsS, Limited).

Suitable inorganic particles include, for example, barium sulfate, calcium carbonate, zinc sulfide, titanium dioxide, silica, and alumina. Usually barium sulfate, zinc sulfide, or titanium dioxide are used. Desirably barium sulfate or titanium dioxide is used.

In one embodiment of the present invention, an additive UV light absorbing particle may be used to decrease the reflectance by the film of light in the 200 to 400 nm wavelength range. Such an additive is typically present in an amount of up to 10.0 wt % and suitably between 0.5 and 10.0 wt %, if it is not used as the void initiating particle. Such an additive is typically present in an amount of up to 70.0 wt % and suitably between 25.0 and 70.0 wt %, if it is also used as the void initiating particle. Titanium dioxide is one such UV light-absorbing particle that is preferred.

The white polylactic acid film according to the present invention must have at least one layer containing inorganic particles present at a concentration in the range of 25.0 to 70.0 wt %, suitably 30-55 wt %, and desirably 40-50 wt %. If the concentration of inorganic particles is below 25.0 wt %, visible light reflection of at least 96% cannot be attained. If the concentration of inorganic particles is above the maximum, the amount of the fine voids is too great, and film breakage occurs in the film formation process. It is, of course, desirable to achieve even higher levels of reflectivity such as 98% or more.

The thickness of a surface light source for an LCD display can be made sufficiently thin by using the white polylactic acid film. Moreover, the white polylactic acid film can be produced at a relatively low cost. Furthermore, since the polylactic acid film has a high heat resistance, a high safety can be ensured even if the film is exposed to a light source having a relatively high temperature. In the present invention, “Polylactic acid” refers to polylactic acid-based polymers or polylactide-based polymers of all isomers that are generally referred to in the art as “PLA”. Therefore, the terms “polylactic acid”, “polylactide”, and “PLA” are used interchangeably in this application to include homopolymers or copolymers of lactic acid or lactide based on polymer characterization of the polymers being formed from a specific monomer or the polymers being comprised of the smallest repeating monomer units. These terms, however, are not meant to be limiting with respect to the manner in which the polymer is formed. The PLA used in this invention includes single D- or L-stereoisomers, or mixtures thereof. Thus, the PLA includes poly(D-lactic acid), poly(L-lactic acid), and mixtures thereof. These are more fully described in Poly(lactide); a Natural “Green” Alternative for Plastic Packaging Materials, Rafael Auras et al., MSU School of Packaging, East Lansing Mich. 48824-1223, USA.

The PLA employed herein is a mixture of poly(D-lactic acid) and poly(L-lactic acid) with the poly(L-lactic acid) comprising between 50 and 99 wt %, typically.

The continuous poly(lactic acid) first phase of the reflective substrate provides a matrix for the other components of the reflective substrate and is transparent to longer wavelength electromagnetic radiation. This poly(lactic acid) phase can comprise a film or sheet of one or more thermoplastic poly(lactic acid)s (individual isomers or mixtures of isomers), which film has been biaxially stretched (that is, stretched in both the longitudinal and transverse directions) to create the microvoids therein around the barium sulfate particles. Any suitable poly(lactic acid) or polylactide can be used as long as it can be cast, spun, molded, or otherwise formed into a film or sheet, and can be biaxially oriented as noted above. Generally, the poly(lactic acid)s have a glass transition temperature of from about 55 to about 65° C. (preferably from about 58 to about 64° C.) as determined using a differential scanning calorimeter (DSC).

Suitable poly(lactic acid)s can be prepared by polymerization of lactic acid or lactide and comprise at least 50% by weight of lactic acid residue repeating units, lactide residue repeating units, or combinations thereof. These lactic acid and lactide polymers include homopolymers and copolymers such as random and/or block copolymers of lactic acid and/or lactide. The lactic acid residue repeating monomer units may be obtained from L-lactic acid, D-lactic acid, or D,L-lactic acid, preferably with L-lactic acid isomer levels up to 75% to provide poly(L-lactic acid). Examples of commercially available poly(lactic acid) polymers include a variety of poly(lactic acid)s that are available from Chronopol Inc. (Golden, Colo.), or polylactides sold under the trade name EcoPLA®. Further examples of suitable commercially available poly(lactic acid) are Natureworks® from Cargill Dow, Lacea® from Mitsui Chemical, or L5000 from Biomer. When using poly(lactic acid), it may be desirable to have the poly(lactic acid) in the semi-crystalline form.

Poly(lactic acid)s may be synthesized by conventionally known methods. They may be synthesized by a direct dehydration condensation of lactic acid, or ring-opening polymerization of a cyclic dimmer (lactide) of lactic acid in the presence of a catalyst. However, poly(lactic acid) preparation is not limited to these processes. Copolymerization may also be carried out in the above processes by addition of a small amount of glycerol and other polyhydric alcohols, butanetetracarboxylic acid and other aliphatic polybasic acids, or polysaccharide and other polyhydric alcohols. Further, molecular weight of poly(lactic acid) may be increased by addition of a chain extender such as diisocyanate.

In the present invention, a polylactic acid comprising a mixture of 96% poly(L-lactic acid) and 4% poly(D-lactic acid) is available commercially and is convenient from the viewpoint processing durability. The lower crystallinity of this polymer results in a less brittle pre-stretched cast sheet allowing for the high levels of inorganic particle concentration without cracks forming prior to stretching. To the polylactic acid, various kinds of known additives, for example, an oxidation inhibitor, or an antistatic agent may be added by a volume which does not destroy the advantages according to the present invention.

In the present invention, the polylactic acid film is whitened by forming fine voids in the film and the resulting diffusion of light by the voids. The use of inorganic particles present at concentrations greater than 25 wt % to initiate the voids results in a high reflectance (at least 96%), which has not been obtained in previously disclosed films at thicknesses less than 150 μm.

In one embodiment of the present invention a second voided polylactic acid layer is adjacent to said inorganic particle voided layer. The two layers may be integrally formed using a co-extrusion or extrusion coating process. The polylactic acid of the second voided layer can be any of the polylactic acids described previously for the inorganic particle voided layer. Suitably the polylactic acid is a polylactic acid comprising a mixture of 96% poly(L-lactic acid) and 4% poly(D-lactic acid) The voids of this second voided layer are formed by finely dispersing a polymer incompatible with the matrix polylactic acid material and stretching the film uniaxially or biaxially. When the film is stretched, a void is formed around each particle of the incompatible polymer. Since the formed fine voids operate to diffuse a light, the film is whitened and a higher reflectance can be obtained. The incompatible polymer is a polymer that does not dissolve into the polylactic acid. Examples of such an incompatible polymer include poly-3-methylbutene-1, poly-4-methylpentene-1, polypropylene, polyvinyl-t-butane, 1,4-transpoly-2,3-dimethylbutadiene, polyvinylcyclohexane, polystyrene, polyfluorostyrene, cellulose acetate, cellulose propionate and polychlorotrifluoroethylene. Among these polymers, polyolefins such as polypropylene are suitable.

The content of the incompatible polymer in the second layer is desirably in the range of 5 to 30 wt %. If the content is lower than the above range, the desired reflectance cannot be obtained. If the content is higher than the above range, the strength of the film becomes too low for processing.

In another embodiment of the invention, a third voided layer meeting the same requirements as the inorganic particle voided first layer is provided adjacent to the second voided layer and on the opposite side from the first inorganic particle voided layer.

Moreover, in another embodiment of the present invention, the mean reflectance of the surface of the white polylactic acid film in the range of wave length of a light of 200 to 400 nm is also preferably less than 40%. This low level of reflectance between 200 and 400 nm can be attained by the addition of UV absorbing particles as described previously.

The process for adding the inorganic particle void initiator or the UV absorbing particles to the polyester matrix is not particularly restricted. The particles can be added in an extrusion process utilizing a twin-screw extruder.

Next, a process for producing a preferred embodiment of the film according to the present invention will be explained. However, the process is not particularly restricted to the following one.

Inorganic particles are mixed into polylactic acid in a twin screw extruder at a temperature of 170-220° C. This mixture is extruded through a strand die, cooled in a water bath, and pelletized. The pellets are then dried at 50° C. and fed into an extruder “A”.

Polypropylene is blended as an incompatible polymer with polylactic acid. After sufficient blending and drying at 50° C., the mixture is supplied to an extruder “B” heated at a temperature of 170-220° C. The two kinds of polymers are co-extruded in a multi-manifold die or feed block in conjunction with a single manifold die to form a laminated structure of A/B or A/B/A.

The molten sheet delivered from the die is cooled and solidified on a drum having a temperature of 40-60° C. while applying either an electrostatic charge or a vacuum. The sheet is stretched in the longitudinal direction at a draw ratio of 2-5 times during passage through a heating chamber at a temperature of 70-90° C. Thereafter, the film is introduced into a tenter while the edges of the film are clamped by clips. In the tenter, the film is stretched in the transverse direction in a heated atmosphere having a temperature of 70-90° C. Although both the draw ratios in the longitudinal and transverse directions are in the range of 2 to 5 times, the area ratio between the non-stretched sheet and the biaxially stretched film is preferably in the range of 9 to 20 times. If the area ratio is less than 9 times, whitening of the film is insufficient. If the area ratio is greater than 20 times, a breakage of the film is liable to occur. Thereafter, the film is uniformly and gradually cooled to a room temperature, and wound.

The white polylactic acid film thus obtained has a high reflectance of not less than 96% in the range of wavelength of a light of 400 to 700 nm. When the white polylactic acid film is used as a substrate for a reflector of a surface light source having a side light system, a high light efficiency can be obtained. Further, since the white polylactic acid film according to the present invention has an excellent mean reflectance in the specified range of wavelength, the film can be utilized for various uses other than a reflector of a surface light source.

Next, the method for determining “mean reflectance” in the present invention will be explained.

Mean reflectance:

A 60 mm integrating sphere is attached to a spectrophotometer (Perkin Elmer Lambda 800). A reflectance is determined in the ranges of wavelengths from 200 to 700 nm. The reflectance of Spectralon is defined as 100% and the measured reflectances are based on a comparison to the Spectralon. A value is obtained at an interval of 1 nm, and the average value over any defined wave length range is defined as the mean reflectance. The mean reflectance at wavelengths from 200 to 400 nm is considered here as UV light reflectivity. The mean reflectance at wavelengths from 400 to 700 nm is considered visible light reflectivity.

### EXAMPLES

Preferred examples will be hereinafter explained together with some comparative examples of commercial reflector films used for side light assemblies. The resulted data are shown in Table 1.

### Example 1

A 3-layer film (with designated layers 1, 2 and 3) comprising voided polylactic acid matrix layers was prepared in the following manner. Materials used in the preparation of layers 1 and 3 of the film were formulated by first compound blending 55% by weight of barium sulfate (BaSO₄) particles, 0.8 μM mean particle size (Blanc Fixe XR-HN available from Sachtleben Corp.), 3% titanium dioxide particles, 0.25 μm mean particle size (Ti-Pure R-104 by DuPont), and 42% by weight poly(lactic acid) resin (NatureWorks 2002-D by Cargill-Dow). The BaSO₄ and titanium dioxide inorganic particles were compounded with the polylactic acid by mixing in a counter-rotating twin-screw extruder attached to a strand die. Strands of extrudate were transported through a water bath, solidified, and fed through a pelletizer, thereby forming pellets of the resin mixture. The pellets were then dried in a desiccant dryer at 50° C. for 12 hours.

As the material for layer 2, poly(lactic acid) resin (NatureWorks 2002-D by Cargill-Dow)was dry blended with polypropylene(“PP”, Huntsman P4G2Z-073AX) at 20% weight and dried in a desiccant dryer at 50° C. for 12 hours.

Cast sheets of the noted materials were co-extruded to produce a combined support having the following layer arrangement: layer 1/layer 2/layer 3, using a 2.5 inch (6.35 cm) extruder to extrude layer 2, and a 1 inch (2.54 cm) extruder to extrude layers 1 and 3. The 200° C. melt streams were fed into a 7 inch (17.8 cm) multi-manifold die also heated at 200° C. As the extruded sheet emerged from the die, it was cast onto a quenching roll set at 50° C. The PP in layer 2 dispersed into globules between 10 and 30 μm in size during extrusion. The final dimensions of the continuous cast multilayer sheet were 18 cm wide and 810 μm thick. Layers 1 and 3 were each 200 μm thick while layer 2 was 410 μm thick. The cast multilayer sheet was then stretched at 82° C. first 3.30 times in the X-direction and then 3.3 times in the Y-direction. The stretched sheet final thickness was 141 μm.

### Example 2

A 3-layer film (with designated layers 1, 2 and 3) comprising voided polylactic acid matrix layers was prepared in the following manner. Materials used in the preparation of layers 1 and 3 of the film were formulated by first compound blending 50% by weight of titanium dioxide particles, 0.25 μm mean particle size (Ti-Pure R-104 by DuPont), and 50% by weight poly(lactic acid) resin (NatureWorks 2002-D by Cargill-Dow). The titanium dioxide inorganic particles were compounded with the polylactic acid by mixing in a counter-rotating twin-screw extruder attached to a strand die. Strands of extrudate were transported through a water bath, solidified, and fed through a pelletizer, thereby forming pellets of the resin mixture. The pellets were then dried in a desiccant dryer at 50° C. for 12 hours.

As the material for layer 2, poly(lactic acid) resin (NatureWorks 2002-D by Cargill-Dow)was dry blended with polypropylene(“PP”, Huntsman P4G2Z-073AX) at 20% weight and dried in a desiccant dryer at 50° C. for 12 hours.

Cast sheets of the noted materials were co-extruded to produce a combined support having the following layer arrangement: layer 1/layer 2/layer 3, using a 2.5 inch (6.35 cm) extruder to extrude layer 2, and a 1 inch (2.54 cm) extruder to extrude layers 1 and 3. The 200° C. melt streams were fed into a 7 inch (17.8 cm) multi-manifold die also heated at 200° C. As the extruded sheet emerged from the die, it was cast onto a quenching roll set at 50° C. The PP in layer 2 dispersed into globules between 10 and 30 μm in size during extrusion. The final dimensions of the continuous cast multilayer sheet were 18 cm wide and 500 μm thick. Layers 1 and 3 were each 125 μm thick while layer 2 was 250 μm thick. The cast multilayer sheet was then stretched at 82° C. first 3.30 times in the X-direction and then 3.3 times in the Y-direction. The stretched sheet final thickness was 104 μm.

### Example 3

A single-layer film comprising a voided polylactic acid matrix layer was prepared in the following manner. Material used in the preparation of the film was formulated by first compound blending 50% by weight of barium sulfate (BaSO₄) particles, 0.8 μm mean particle size (Blanc Fixe XR-HN available from Sachtleben Corp.) and 50% by weight poly(lactic acid) resin (NatureWorks 2002-D by Cargill-Dow). The barium sulfate inorganic particles were compounded with the polylactic acid by mixing in a counter-rotating twin-screw extruder attached to a strand die. Strands of extrudate were transported through a water bath, solidified, and fed through a pelletizer, thereby forming pellets of the resin mixture. The pellets were then dried in a desiccant dryer at 50° C. for 12 hours.

Cast sheets of the noted material was extruded to produce a support using a 2.5 inch (6.35 cm) extruder. The 200° C. melt stream was fed into a 7 inch (17.8 cm) filming die also heated at 200° C. As the extruded sheet emerged from the die, it was cast onto a quenching roll set at 50° C. The final dimensions of the continuous cast sheet was 18 cm wide and 800 μm thick. The cast sheet was then stretched at 82° C. first 3.30 times in the X-direction and then 3.3 times in the Y-direction. The stretched sheet final thickness was 189 μm.

### Example 4

A single-layer film comprising a voided polylactic acid matrix layer was prepared in the following manner. Material used in the preparation of the film was formulated by first compound blending 40% by weight of titanium dioxide particles, 0.25 μm mean particle size (Ti-Pure R-104 by DúPont) and 60% by weight poly(lactic acid) resin (NatureWorks 2002-D by Cargill-Dow). The titanium dioxide inorganic particles were compounded with the polylactic acid by mixing in a counter-rotating twin-screw extruder attached to a strand die. Strands of extrudate were transported through a water bath, solidified, and fed through a pelletizer, thereby forming pellets of the resin mixture. The pellets were then dried in a desiccant dryer at 50° C. for 12 hours.

Cast sheets of the noted material was extruded to produce a support using a 2.5 inch (6.35 cm) extruder. The 200° C. melt stream was fed into a 7 inch (17.8 cm) filming die also heated at 200° C. As the extruded sheet emerged from the die, it was cast onto a quenching roll set at 50° C. The final dimensions of the continuous cast sheet was 18 cm wide and 780 μm thick. The cast sheet was then stretched at 82° C. first 3.30 times in the X-direction and then 3.3 times in the Y-direction. The stretched sheet final thickness was 113 μm.

The comparative samples below are all commercial reflector films designed for side light assemblies for LCD's. The Manufacturer and product code names are given. These samples represent what are considered the state of the art in commercial reflector films.
Comparative 1 Keiwa, BR-1
Comparative 2 Kimoto, RW 125
Comparative 3 Kimoto, RW 75CB
Comparative 4 Kimoto, RW X3T
Comparative 5 Kimoto, RW 188
Comparative 6 Tsujiden, RF-75
Comparative 7 Tsujiden, RF-188
Comparative 8 Tsujiden, RF-195E
Comparative 9 Tsujiden, RF-215G
Comparative 10 Tsujiden, RF-220EG
Comparative 11 Tsujiden, MTN-W400

The comparative samples along with the examples of the present invention are listed in Table 1. A description by manufacturer and code number are given for the comparative samples and a description by the inorganic particle voided layer(s) material content are given for the examples of the present invention. The thickness of each sample was measured and is listed. Reflectance measurements were made on all the samples as well. The mean reflectance at wavelengths from 400 to 700 nm is given as the visible reflectance for each sample. The mean reflectance from 200 to 400 nm is given as the UV reflectance for each sample.

TABLE 1

| | | | VISIBLE | UV |
|---|---|---|---|---|
| | | | REFLECTANCE | REFLECTANCE |
| | | THICKNESS | (400-700 nm) | (200-400 nm) |
| SAMPLE | DESCRIPTION | (μm) | (%) | (%) |
| Comparative 1 | Keiwa BR-1 | 206 | 95.7 | 50.7 |
| Comparative 2 | Kimoto RW 125 | 122 | 92.2 | 49.4 |
| Comparative 3 | Kimoto RW 75CB | 107 | 92.4 | 41.8 |
| Comparative 4 | Kimoto RW X3T | 137 | 92.5 | 9.4 |
| Comparative 5 | Kimoto RW 188 | 188 | 94.9 | 51.5 |
| Comparative 6 | Tsujiden RF-75 | 81 | 85.3 | 47.7 |
| Comparative 7 | Tsujiden RF-188 | 183 | 94.2 | 50.3 |
| Comparative 8 | Tsujiden RF-195E | 188 | 94.6 | 47.0 |
| Comparative 9 | Tsujiden RF-215G | 216 | 95 | 50.0 |
| Comparative 10 | Tsujiden RF-220EG | 218 | 94.9 | 47.1 |
| Comparative 11 | Tsujiden MTN-W400 | 249 | 94.9 | 50.3 |
| Coex Examples | | | | |
| Example 1 | PLA/BaSO₄ w/ 3% TiO₂ | 141 | 97.3 | 18.8 |
| Example 2 | PLA/TiO₂ | 104 | 97 | 35 |
| 1 Layer Examples | | | | |
| Example 3 | PLA/BaSO₄ (No TiO₂) | 189 | 98.3 | 78 |
| Example 4 | PLA/TiO₂ | 113 | 97.2 | 17.3 |

It can be seen that none of the comparative samples have a visible reflectance of at least 96% while all the examples of the present invention are at least 96% and in fact are greater than 97%. Also, only one comparative sample has UV reflectance less than 40% (comparative 4) but again its visible reflectance is less than 96%. Examples 1, 2 and 4 of the present invention all have UV reflectance significantly below 40% while maintaining visible reflectance of at least 96%.

The invention has been described in detail with particular reference to certain preferred embodiments thereof, but it will be understood that variations and modifications can be affected within the scope of the invention. The entire contents of the patents and other publications referred to in this specification are incorporated herein by reference.

1. A reflective optical film comprising a layer containing a polylactic acid voided with inorganic particles in a size and an amount sufficient to provide a visible light reflectivity of at least 96%.

2. The film of claim 1 further comprising dispersed UV absorbing particles in amounts sufficient to provide a UV light reflectivity of less than 40%.

3. The film of claim 1 wherein said polylactic acid comprises poly(L-lactic acid) or poly(D-lactic acid).

4. The film of claim 1 wherein said polylactic acid is a mixture of poly(L-lactic acid) and poly(D-lactic acid).

5. The film of claim 1 wherein the inorganic particles are present in an amount between 25 to 70 wt %.

6. The film of claim 1 wherein the inorganic particles include barium sulfate or titanium dioxide.

7. The film of claim 2 wherein the UV absorbing particles are present in an amount between 0.5 and 10.0 wt %.

8. The film of claim 7 wherein the UV absorbing particles include titanium dioxide.

9. The film of claim 1 wherein said inorganic particles have an average size from 0.1 to 10.0 μm.

10. The film of claim 1 wherein said inorganic particles have an average size from 0.3 to 2.0 μm.

11. The film of claim 1 wherein the film contains a second voided polylactic acid layer adjacent to and integral with the polylactic acid voided layer with inorganic particles.

12. The film of claim 11 wherein the second voided polylactic acid layer comprises a polymer that is immiscible with polylactic acid as voiding agent.

13. The film of claim 12 wherein the polymer that is immiscible with polylactic acid is polypropylene.

14. The film of claim 12 wherein the polymer that is immiscible with polylactic acid is present in the layer at 5 to 30 wt % of the second layer.

15. The film of claim 11 wherein the second voided polylactic acid layer comprises poly(L-lactic acid) or poly(D-lactic acid).

16. The film of claim 11 wherein the second voided polylactic acid layer comprises a mixture of poly(L-lactic acid) and poly(D-lactic acid).

17. The film of claim 11 wherein a third voided polylactic acid layer, containing inorganic particles, is adjacent to and integral with the second voided polylactic acid layer and on the opposite side of the second layer from the first voided polylactic acid layer with inorganic particles.

18. An LCD display comprising the film of claim 1.

19. An LCD display comprising the optical film of claim 2.
